(19) United States
(12) Patent Application Publication
(10) Pub. No.: US 2008/0126758 A1
(43) Pub. Date: May 29, 2008

(54) Digital signal processing apparatus and method for multiply-and-accumulate operation

(76) Inventors: Young-Su Kwon, Daejon (KR); Bon-Tae Koo, Daejon (KR); Nak-Woong Eum, Daejon (KR)

Correspondence Address: LADAS & PARRY LLP, 224 SOUTH MICHIGAN AVENUE, SUITE 1600, CHICAGO, IL, 60604, US

(21) Appl. No.: 11/644,724

(22) Filed: Dec. 22, 2006

(30) Foreign Application Priority Data
Sep. 20, 2006 (KR) 10-2006-0091313

(51) Int. Cl. G06F 9/302

(52) U.S. Cl. 712/221; 712/E09.017

(57) ABSTRACT

A digital signal processing apparatus and method for MAC operation are disclosed. The DSP apparatus including: a first memory for storing a plurality of first operands; a second memory for storing a plurality of second operands; a MAC processor including a plurality of parallel MAC blocks disposed in parallel for performing a parallel MAC operation on a first operand outputted from the first memory in parallel and a second operand outputted from the second memory in parallel using the parallel MAC blocks, wherein the first memory and the second memory include dual port memories for outputting the plurality of the first operands and the second operands to the plurality of parallel MAC blocks in parallel.

### FIELD OF THE INVENTION

The present invention relates to a digital signal processing apparatus and method for multiply-and-accumulate (MAC) operation; and, more particularly, to a digital signal processing apparatus and method for multiply-and-accumulate (MAC) operation to improve a memory access bandwidth for parallel MAC operation and to prevent accumulation register from being overflowed.

### DESCRIPTION OF RELATED ART

In generally, various electron devices such as a wireless communication terminal, a personal digital assistant (PDA), an asynchronous transfer mode (ATM) switch, a digital audio/video device, are required to quickly process a mass amount of digital data. The DSP is a processor for performing predetermined digital signal processing operations. The DSP is designed to effectively perform calculation using the characteristics of specific digital signal processing operation.

A digital signal processing operation performed by the DSP has a characteristic that performs the repetitive operations on a mass amount of consecutive data in the same manner. The mass amount of data is stored in the memory while the DSP reads those operands, execute the operation on the operands, and stores the result in the memory.

In digital signal processing operation, a multiply-and-accumulate (MAC) is an essential operation. The MAC operation is expressed as Eq. 1. The MAC operation is used in filtering algorithms such as a finite impulse response (FIR) filter and an infinite impulse response (IIR) filter or various digital signal processing algorithms such as fast fourier transform (FFT) or inverse fast fourier transform (IFFT).

$$Z = {\sum }_{i - 0}^{p 1} {X}_{i} \times {Y}_{i} \qquad Eq . 1$$

In order to effectively support the MAC operation, a DSP generally includes a MAC block. The MAC block is dedicated hardware for effectively calculating the MAC operation. The MAC block includes a multiplier, an adder, and an accumulator. The MAC block performs a MAC operation by multiplying two operands using the multiplier, adding the multiplication result with a value stored in the accumulator using the adder, and storing the added value into the accumulator.

In order to increase the speed of the MAC operation in the DSP, the DSP supports parallel MAC operations. That is, the DSP may include two parallel MAC blocks (Dual-MAC) or four parallel MAC blocks (Quad-MAC), thereby accelerating the MAC operation.

The required number of operands in the Dual-MAC block is two times larger than that of the general MAC block. Since a conventional single-port memory block support only a single operand fetch at one cycle, the DSP with parallel MAC blocks suffers from a limitation of a memory access bandwidth. Also, the MAC block is easily overflowed due to the limitation of the bit-width of the accumulator during the repetitive accumulation of the multiplication results.

In order to overcome the limitation of memory access bandwidth, a conventional method of using a register file was introduced. The register file allows parallel blocks to access each register independently. Therefore, the DSP initially stores operands read from the memory in the register file and allows the parallel MAC blocks to access the stored values in the register files at the same time, thereby expanding the register access bandwidth. However, in order to use the register file, the DSP must have not only a mass amount of register file, but also need additional clock cycles to store data in the register file.

As another conventional method to overcome the limitation of memory access bandwidth, a method using a memory block was introduced. In this conventional method using the memory block, operands are stored at different memory blocks, and the stored operands are read at the same time. However, a programmer needs to carefully assign the location of operands in writing the program such that the operands are located in a predetermined format to maximize the memory bandwidth.

As a conventional method for preventing the accumulator from being overflowed, a method of providing guard bits was introduced. This conventional method reduces the overflow generation by increasing the bit width of the accumulator to 6 to 10 bits in order to minimize the generation of overflow in adding operations. However, the number of bits required for the accumulation of a mass amount of multiplication results is inestimable. Therefore, the fixed bit-width of the accumulator still makes the possibility of generating overflow.

### SUMMARY OF THE INVENTION

It is, therefore, an object of the present invention to provide a digital signal processing apparatus having an enhanced memory access bandwidth by allowing simultaneous access of a plurality of operands required for a parallel MAC operation, and a method thereof.

It is another object of the present invention to provide a digital signal processing apparatus for preventing an accumulator from being overflowed in a MAC block without requiring additional clock cycle while performing a MAC operation, and a method thereof.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a digital signal processing apparatus performing a MAC operation, including: a first memory for storing a plurality of first operands; a second memory for storing a plurality of second operands; a MAC block including a plurality of parallel MAC blocks disposed in parallel for performing a parallel MAC operation on the first operands outputted from the first memory and the second operands outputted from the second memory using the parallel MAC blocks, wherein the first memory and the second memory include dual port memories for outputting the plurality of the first operands and the second operands to the plurality of parallel MAC blocks in parallel.

The first memory and the second memory may include two dual port memories, and the MAC processor includes four parallel MAC blocks that perform a parallel MAC operation on four first operands outputted from the two dual port memories of the first memory and four second operands outputted from two dual port memories of the second memory in parallel.

The MAC block may include: an accumulator for storing a MAC operation result; an exponent counter for storing an exponent value that denotes the number of right-shifted bits of a values stored in the accumulator; a multiplier for multiplying the first operand outputted from the first memory and a second operand outputted from the second memory; a first right shifter for shifting an output value of the multiplier in the right direction as much as the exponent value; an adder for adding an output value of the first right shifter and a value stored in the accumulator, and outputting a carry if the adding result exceeds a bit width supported by the accumulator; and a second right shifter for shifting the adding result in a right direction by one when the carry is generated, wherein the exponent counter increases the exponent value when the carry is generated, and the accumulator stores the output value of the second right shifter as the result of the MAC operation.

The MAC processor may further include an arithmetic processor for adding four MAC operation results stored in the accumulators accompanied by the exponent value of the four MAC blocks.

The arithmetic processor may includes: a shift unit for shifting the four accumulators of the four MAC blocks as much as a difference between the largest exponent value among four exponent values stored in the exponent counters in the four MAC blocks and an exponent value stored in an exponent counter of a corresponding MAC block; and an adding unit for adding the shifted four MAC operation results.

In accordance with another embodiment of the present invention, there is an apparatus for performing a multiply-and-accumulate (MAC) operation on a first operand and a second operand, including: an accumulator for storing a MAC operation result of the first operand and the second operand; an exponent counter for storing an exponent value denoting the number of right-shifted bits of the MAC operation result stored in the accumulator; a multiplier for multiplying the first operand and the second operand; a first right shifter for shifting the multiplication result of the multiplier as much as the exponent value; an adder for adding an output value of the first right shifter and a value stored in the accumulator, and outputting a carry when the adding result exceeds a bit width supported by the accumulator; and a second right shifter for shifting the adding result in a right direction when the carry is generated, wherein the exponent counter increases the stored exponent value when the carry is generated, and the accumulator stores the output value of the second right shifter as a new MAC operation result. The adder may have a bit width identical to that of the accumulator. An exponent value in the exponent counter increases, and the new MAC operation result is stored in the accumulator at the same clock.

In accordance with yet another embodiment of the present invention, there is provided a storage device for storing an operand used in a parallel multiply-and-accumulate (MAC) operation of a digital signal processing apparatus having a plurality of MAC blocks arranged in parallel, including: a storing unit for storing a plurality of operands used for a parallel MAC operation; and an address generator for generating a plurality of operand addresses for outputting a plurality of operands from the storing unit in parallel, wherein the storing unit is embodied as a dual port memory that allows simultaneous access of two memory regions. The storing unit may include: a first dual port memory for storing an operand having an odd address; and a second dual port memory for storing an operand having an even address.

In accordance with still another embodiment of the present invention, there is provided a method of performing a multiply-and-accumulate (Mac) operation in a digital signal processing apparatus that performs a MAC operation of a first operand and a second operand, including the steps of: a) storing an exponent value denoting a number of right shifted bits of a MAC operation result stored in an accumulator; b) multiplying the first operand and the second operand and shifting the multiplication result in a right direction as much as the exponent value; c) adding the shifted multiplication result to a MAC operation result value stored in the accumulator; d) shifting the adding result if the adding result exceeds a bit width of the accumulator; e) storing the right-shifted adding value at the accumulator as a new MAC operation value; and f) increasing an exponent value that increases the stored exponent value.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram illustrating a digital signal processing apparatus in accordance with an exemplary embodiment of the present invention;

FIG. 2 is a block diagram depicting a sub memory block with data stored in interleaving scheme in accordance with an exemplary embodiment of the present invention;

FIG. 3 is a block diagram showing a MAC block for preventing overflow in accordance with an exemplary embodiment of the present invention; and

FIG. 4 is a diagram for describing a MAC operation for preventing overflow in accordance with an exemplary embodiment of the present invention.

### DETAILED DESCRIPTION OF THE INVENTION

Other objects and aspects of the invention will become apparent from the following description of the embodiments with reference to the accompanying drawings, which is set forth hereinafter.

A multiply-and-Accumulate (MAC) operation can be expressed as following Eq. 2.

$$Z = {\sum }_{i - 0}^{P 1} {X}_{i} \times {Y}_{i} \qquad Eq . 2$$

In Eq. 2, Z denotes a final result of a MAC operation, and Xᵢ and Yᵢ denote the arrangement of operands stored in a memory. A MAC block is a block performing a MAC operation by multiplying two operands and adding it to an accumulator. In case of using single MAC block, p clock cycles are needed for the MAC operation like as Eq. 2.

The MAC operation of Eq. 2 can be expressed as following Eq. 3.

$$Z = {\sum }_{i = 0}^{p / 4 - 1} ( {X}_{4 i} \times {Y}_{4 i} + {X}_{4 i + 1} \times {Y}_{4 i + 1} + {X}_{4 i + 2} \times {Y}_{4 i + 2} + {X}_{4 i + 3} \times {Y}_{4 i + 3} ) \qquad Eq . 3$$

In Eq. 3, Z denotes a final result of a MAC operation, and Xᵢ and Yᵢ denote the arrangement of operands stored in a memory. In case of using four parallelized MAC blocks, each of multiplying terms is calculated at a corresponding one of the four MAC blocks and accumulated. At the last clock cycle, the results of four MAC blocks are added together, thereby calculating the value of Z. If four parallel MAC blocks are used as described above, the MAC operation of Eq. 3 can be calculated at p/4 clock.

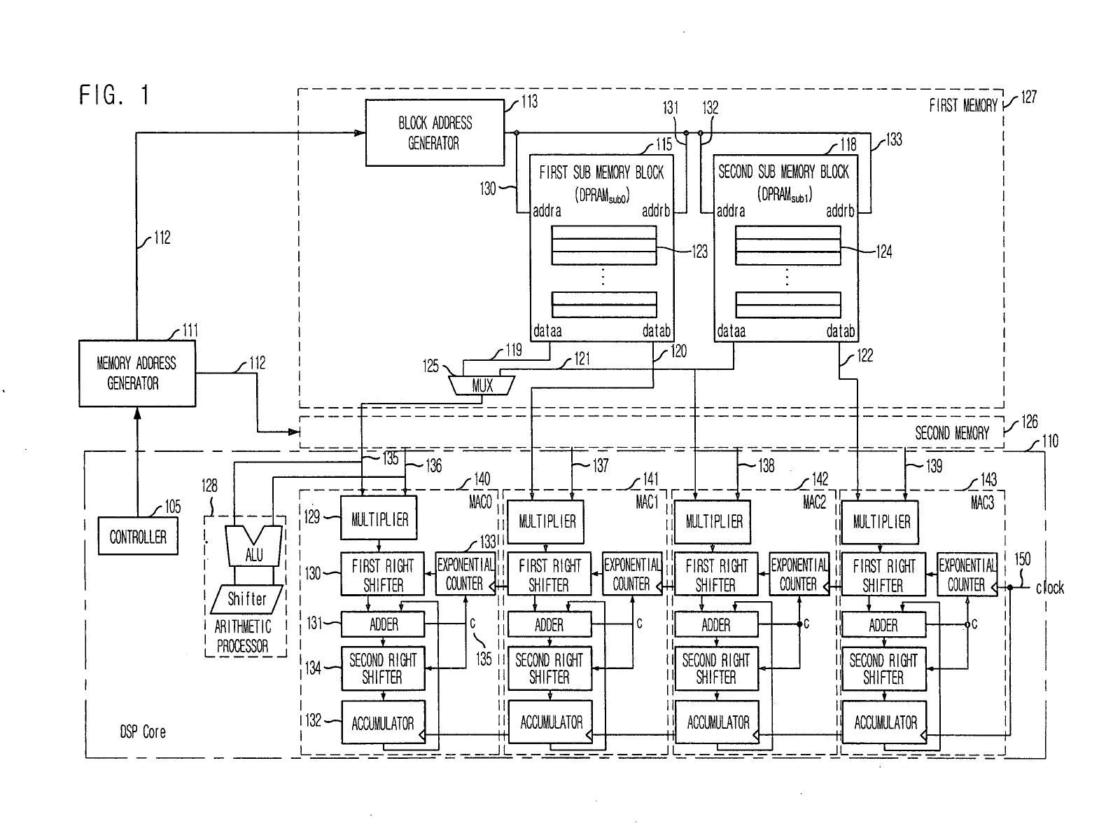

FIG. 1 is a block diagram illustrating a digital signal processing apparatus in accordance with an exemplary embodiment of the present invention. FIG. 1 shows a digital signal processing apparatus performing a parallel MAC operation using four MAC blocks according to an embodiment of the present invention. However, the number of MAC blocks in the digital signal processing apparatus can change according the required specification of a digital signal processor (DSP)

As shown in FIG. 1, the digital signal processing apparatus according to the present embodiment includes a first memory 127 for storing a first operand, a second memory 126 for storing a second operand, a DSP core 110 for performing a MAC operation on the first and second operands, and a memory address generator 11 for generating a memory address to enable the DSP core 110 to output the first operand and the second operand from the first memory and the second memory at a predetermined clock cycle.

The first memory 127 includes a first sub memory block 115 and a second sub memory block 118 for parallelizing four operands for a MAC operation and outputting the parallelized four operands to four MAC blocks 140 to 143 in the DSP core 110. The first memory 127 also includes a block address generator 113 for generating a sub block address to access the first and second sub memory blocks 115 and 118 from the memory address generated from the memory address generator 111. In case of performing a single MAC operation without using a plurality of MAC blocks, a MUX 125 may be additionally included in the first memory 127 to select one of two operands. The first sub memory block 115 and the second sub memory block 118 are configured as a dual-port memory to allow simultaneous access of two memory areas. Hereinafter, a DPRAMsub0 115 and a DPRAMsub1 118 denote the first sub memory block 115 and the second sub memory block 118, respectively. Since the structure and operation of the second memory 126 are identical to those of the first memory 127, the detailed description of the second memory thereof will be omitted.

The DSP core 110 includes a controller 105 for controlling the memory address generator 110 to generate a memory address for outputting operands required for the MAC operation to a signal processor performing a MAC operation in the parallel MAC block with the first and second operands, and MAC blocks 140 to 143 for performing a MAC operation on operands that are parallelized and outputted from the first and second memories 127 and 126, and an arithmetic processor 128 for adding accumulator values in the parallelized MAC blocks 140 to 143.

Each of the parallelized MAC blocks 140 to 143 includes a multiplier, a first right shifter, an adder, an exponent counter EC, a second right shifter, and an accumulator. Each of the MAC blocks has the same structure and is operated by the same clock 50.

Since each of the first to fourth MAC blocks in the DSP core 110 has the same structure, the first MAC block 140 is representatively described, hereinafter. The first MAC block 140 includes a multiplier 129, a first right shifter 130, an adder 131, an exponent counter EC 133, a second right shifter 134, and an accumulator 132. The multiplier 129 multiplies a first operand outputted from the first memory 127 and a second operand 136 outputted from the second memory 126. The first right shifter 130 shifts the multiplication result of the multiplier 129 in a right direction as much as an exponent value stored in the EC 33. The adder 131 adds the output value from the first right shifter 130 to a value stored in the accumulator 132, and transfers a carry 133 to the EC 133 and the second right shifter 134 if the adding result is overflowed. The EC 133 increases the exponent value when receiving the carry 135 from the adder 131. The second right shifter 134 shifts the adding result of the adder 131 in the right direction by one bit when receiving the carry 135 from the adder 131. The accumulator 132 stores the output value of the second shifter 134.

Hereinafter, the operation of the digital signal processing apparatus according to an embodiment of the present invention will be described with reference to FIG. 1.

The controller 105 fetches an instruction from a program memory for a predetermined operation performed at a current clock cycle. Then, the controller 105 transfers the instruction to the data address generator 111 so as to enable the data address generator 111 to calculate and generate the memory addresses of operands required for an operation performed at a current clock cycle. The data address generator 111 can calculate a memory address of operand using a predetermined value encoded into a command or an instruction. The data address generator 111 generates a memory address 112 of operand according to the instruction received from the controller 105 and transfers the generated memory address 112 to the first and second memories 127 and 126.

The first and second memories 127 and 126 parallelize four operands to perform a MAC operation and output the parallelized four operands to four MAC blocks 140 to 143 in the DSP core. Since the first and second memory blocks 127 and 126 perform the same operations, the operations of the memory blocks will be described using the first memory block 127 as a representative example.

The block address generator 113 of the first memory block 127 generates sub block addresses 130, 131, 132 and 133 based on the memory address 112 received from the memory address generator 112 in order to access the sub memory blocks 115 and 118. Meanwhile, the sub memory blocks 115 and 118 are configured as a dual port memory that allows simultaneous access of two memory regions. Therefore, the first memory 127 and the second memory 126 in FIG. 1 allow simultaneous access of four memory regions at one clock cycle.

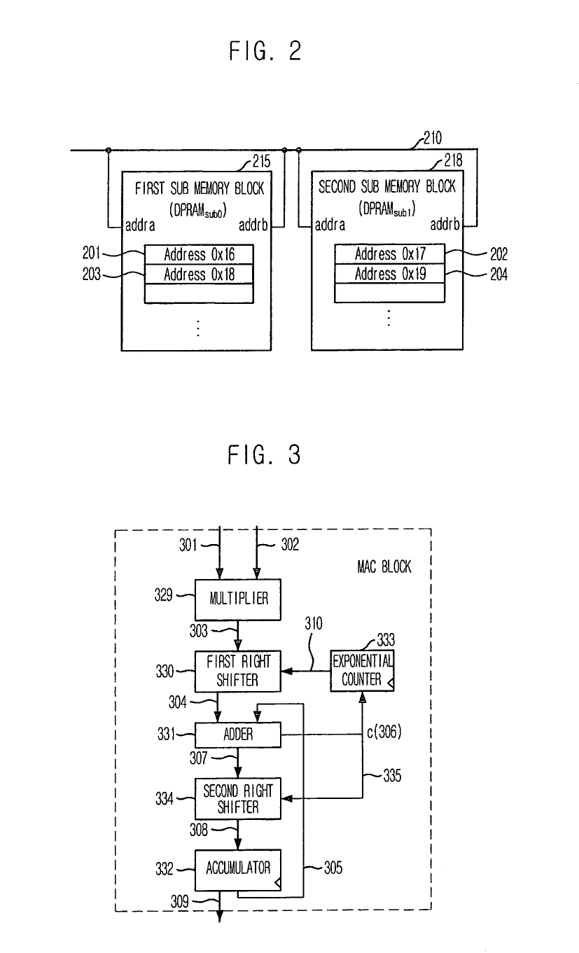

Although the first sub memory block (DPRAMsub0) 115 is logically distinguished from the second sub memory block (DPRAMsub1) 118, they constitute a continuous memory area in the view of an operand memory. In more detail, the DPRAMsub0 115 stores data having an operand address having the least significant bit of 0, and the DPRAMsub1 118 stores data having an operand address having the least significant bit of 1. As described above, a method of storing data array having a linear address alternatively in different memory blocks is an interleaving storing scheme. A memory block storing data based on the interleaving storing method is an interleaving sub block. In the present embodiment, the memory access bandwidth can be improved using the interleaving sub block and the dual port memory. The first sub block (DPRAMsub0) 115 and the second memory block (DPRAMsub1) 115 are interleaving sub blocks. The first sub memory block 115 stores an operand 23 with an even address, and the second memory block 118 stores an operand 24 with an odd address as shown in FIG. 2.

FIG. 2 is a block diagram depicting a sub memory block with data stored in interleaving scheme in accordance with an exemplary embodiment of the present invention.

As shown in FIG. 2, in case of storing operands placed at an address 0x16 to an address 0x19 in sub memory blocks 215 and 218, operands 201 and 203 which have a memory address with the least significant bit of 0 are stored in the first sub memory block (DPRAMsub0) 215, and operands 202 and 204 which have a memory address with the least significant bit of 1 are stored in the sub memory block (DPRAMsub1) 218.

The block address generator 113 generates sub block addresses 130 to 133 to read operands stored in the sub memory blocks 115 and 118 in the interleaving scheme. That is, the block address generator 113 generates an address having the least significant bit of 0 for the first sub memory block 115, and generates an address having the least significant bit of 1 for the second sub memory block 118. Referring to FIG. 2, the sub block addresses 130, 131, 132, and 133 are ‘0x16’, ‘0x18’, ‘0x17’, and ‘0x19’ to read four data from the operand address 0x16. The memory address generator 111 increases a memory address into ‘0x20’ in order to read operands at the next cycle.

In case of performing a MAC operation using four MAC blocks 140 and 143 as described above, the memory address generator 111 increases the memory address 112 as many as the number of the MAC blocks at a clock cycle for a next operation, the block address generator 113 generates sub block addresses 130 to 133 to read four operands stored in the sub block memories 115 and 118 based on the interleaving scheme, and the sub block memories 115 and 118 output four operands 119 and 122.

In case of a general digital signal operation that dose not need to perform a plurality of MAC operations at the current clock cycle, each of the first memory 127 and the second memory 126 must output one operand. That is, in case of an adding operation, a shifting operation, or an operation using a single MAC block, each of the first and second memories 127 and 126 needs to select one of operands stored in the first sub memory block 115 and the second sub memory block 118. Therefore, when the first and second memories 127 and 126 needs to output one operand, the first and second memories 127 and 126 use the MUX 125 to select one of operands stored in the interleaving sub blocks and outputs the selected one operand. Referring to FIG. 2, if the memory address of an operand required for the operation at the current clock cycle is ‘0x16’, the MUX 125 selects an operand outputted from the first sub memory block 215. In this case, sub block addresses 130, 131, 132, and 133 outputted from the block address generator 113 are ‘0x16’, ‘don't care’, ‘0x17’, and ‘don't care’. The output data 135 and 136 outputted form the MUX disposed in the first memory and the second memory are inputted to the arithmetic processor 128 and the first MAC bock 132.

Hereinafter, the operation of a DSP core 110 for performing a MAC operation will be described.

In case of performing a MAC operation using four MAC blocks MAC0 140 to MAC3 143, the four operands 119 to 122 outputted from the first memory 127 and four operands 136 to 139 outputted from the second memory 126 are inputted to the first MAC block MAC0 140, the second MAC block MAC1 141, the third MAC block 142, and the fourth MAC block MAC3 143. Each of the MAC blocks 140 to 143 performs a MAC operation by multiplying two operands and adding the multiplication result to the accumulator. However, if the number of operands to be multiplied through the MAC operation increases, that is, if the value of ‘p’ in Eq. 3 increases, an accumulator may be overflowed due to the limited bit-width of the accumulator while accumulating the multiplication results in the accumulator. In order to prevent an accumulator from being overflowed, the multiplication results are periodically checked while accumulating and adding them with the values of the accumulators in the conventional DSPs. Such a checking operation requires an additional clock cycle which degrades the performance of the conventional DSPs.

In the MAC operation according to the present embodiment, the possibility of overflow generation is eliminated without using additional clock cycle by reducing a resolution using a carry c when the adding result exceeds a value that can be expressed by the accumulator. Each of the MAC blocks 140 to 143 has the same structure and performing the identical operation, the MAC blocks 140 and 143 will be described using the first MAC block as a representative example.

If the output value of the adder 131 exceeds the value expressed by the accumulator 132 at any clock cycle while performing the MAC operation, that is, if the overflow occurs, a carry c 135 is generated from an adding operation. If the adder 131 is configured to output a carry and has a bit width identical to that of the accumulator 132, the carry 135 generated from the adder 131 denotes that the adding result exceeds a value that can be expressed by the accumulator 132. When the carry 135 is generated, the EC 133 increases the exponent value stored in a register by one at a corresponding clock cycle, and the second right shifter 134 shifts the output value of the adder 131 in the right direction by one bit. If the carry 135 is not generated, the output value of the adder 131 is not shifted. Then, the output value of the second right shifter 134 is stored in the accumulator 132. The storing operations of the accumulator 132 and the EC 133 are performed by the same clock 150.

The multiplier 129 multiplies the first operand 135 outputted from the first memory 127 and the second operand 136 outputted from the second memory 126 at every clock cycle. The first right shifter 130 shifts the output value of the multiplier 129 in the right direction as much as the output value of the EC 133. That is, the resolution of the output value of the multiplier 129 is reduced as much as the current exponent value, and then accumulated. If the exponent value is large, it denotes that the actual value stored in the accumulator 132 is large.

At the last step of the MAC operation, the accumulated value at the accumulators of the MAC blocks 140 to 143 are inputted to the arithmetic processor 128, thereby adding the accumulated values. That is, in case of Eq. 3, the arithmetic processor 128 outputs the final MAC result at the (p/4+1)-th clock cycle. In case of using such a MAC operation according to the present embodiment, it can prevent the final result of the MAC operation from being overflowed without checking the result of the adder included in the MAC block at every clock cycle.

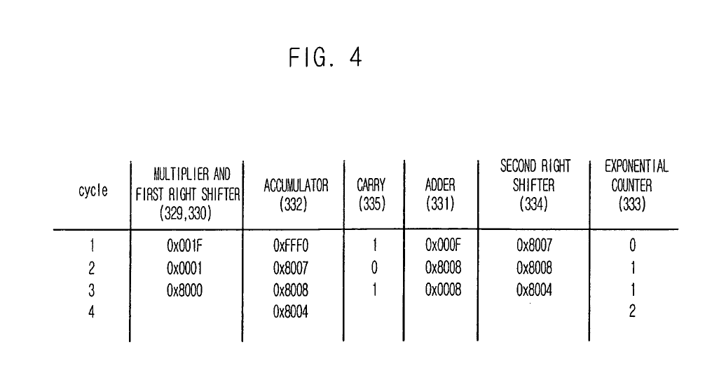

FIG. 3 is a block diagram showing a MAC block for preventing overflow in accordance with an exemplary embodiment of the present invention, and FIG. 4 is a diagram for describing a MAC operation for preventing overflow in accordance with an exemplary embodiment of the present invention. It assumes that the bit-width of the accumulator 332 is 16 bits, while the adder 331 is a 16 bit adder that outputs a carry.

Referring to FIGS. 3 and 4, the exponent value stored in the EC 333 is 0 at the first clock cycle. Therefore, when the multiplier 329 multiplies the first operand 301 and the second operand 302 and outputs the multiplication result 303 as ‘0x001F’, the first right shifter also outputs the output value of ‘0x001F’. The current value in the accumulator 332 is ‘0xFFF0’, and thus the output of the adder 331 becomes ‘0x000F’ while generating a carry 335. The generation of a carry 335 means that the value to be stored in the accumulator exceeds the range of expressible value with 16-bit register. Since the carry 335 is generated, the second right shifter 334 shifts the output value 307 of the adder in the right direction by one bit. Therefore, the second right sifter 334 outputs the value of ‘0x8007’. The right shifter 334 performs a right shift only if the carry is generated, and the shift operation is performed with the carry value included. Therefore, if the second right shifter 334 performs the right shift operation, the most significant bit of the output value thereof always becomes 1.

The multiplier 302 outputs the value 303 of ‘0x0002’ at the second clock cycle (cycle 2), and the first right shifter 330 outputs a value 304 of ‘0x0001’. Since the output value 310 of the EC 333 is ‘1’, the first right shifter 330 shifts the output value of the multiplier in the right direction by one, thereby outputting the value 304 of ‘0x0001’. Although the adder 331 outputs the value of ‘0x8008’, the carry is not generated. Therefore, the exponent value of the EC 333 does not increase. That is, the exponent value at the third clock cycle (cycle 3) is not changed at the second clock cycle (cycle 2). The accumulator 332 stores a value of ‘0x8008’ at the third clock cycle 3.

The first right shifter 330 outputs a value of ‘0x8000’ at the third clock cycle after multiplication in the multiplier 302 and shifted as much as the exponent value, the adder 331 outputs a value 307 of ‘0x0008’ and the carry is generated. Since the carry is generated, the second right shifter 334 performs the one bit right shift operation, and outputs the value of ‘0x8004’. Therefore, at the fourth clock cycle (cycle 4), the accumulator 332 has an accumulated value of ‘0x8004’, and the exponent value of the EC 333 becomes 2.

If the bit-widths of the accumulator and the adder are not limited, an initial accumulated value ‘0xFFF0’ is added with multiplication results ‘0x001F’, ‘0x0002’, and ‘0x10000’. Therefore, the final result of the MAC operation becomes ‘0x200011’. On the contrary, the result of the MAC block according to the present embodiment becomes ‘0x20010’ because the accumulator 332 stores the accumulated value ‘0x8004’ and the EC 333 stores the exponent value of 2. In conclusion, the MAC block according to the present invention generates less error although the number of bits of the accumulator 332 is limited by 16 bits.

In the last step of the MAC operation using a plurality of parallel MAC blocks, the programmer needs to add the accumulated values stored in the accumulators in the parallel MAC blocks. Such an addition may be performed in the arithmetic processor in the DSP core. The arithmetic processor includes an arithmetic logic unit (ALU) and a shifter. The arithmetic processor needs to consider the exponent value for the output of the accumulator in each MAC block for adding the output values of the accumulators in the MAC blocks. That is, when the MAC operation results obtained from four MAC blocks are added, the largest exponent value is searched among the four exponent values in exponent counters 333, the output values of four accumulators are shifted in the right direction as much as a difference between an exponent value of a corresponding block and the largest exponent value, and the shifted values added together. For example, when values stored in accumulators in four MAC blocks are ‘0xC001’, ‘0x8000’, ‘0xF000’, and ‘0x8004’, and the exponent values are ‘1’, ‘1’, ‘2’, and ‘4’, the accumulated values are shifted in the right direction by 3, 3, 2, and 0, respectively, because the maximum exponent value is 4, and then the shifted values are added together. Therefore, the arithmetic processor outputs the final MAC operation result ‘0xE404’ by adding ‘0x1800’, ‘0x1000’, ‘0x3C00’, and ‘0x8004’ together, and the exponent value becomes 4. In this case, the real value of the final MAC operation result is ‘0xE4040’.

As described above, the digital signal processing apparatus according to the present invention includes a memory formed of dual port sub memories. Therefore, operands as many as two times of sub memory blocks can be simultaneously accessed at one clock cycle. The digital signal processing according to the present invention stores operands in the memory based on the interleaving storing method. Therefore, the digital signal processing apparatus according to the present invention can effectively access the operands.

Also, the digital signal processing apparatus according to the present invention includes an exponent counter and shifters in the MAC block. If the accumulator receives a value that cannot be expressed, the adding operation is performed after reducing the resolution thereof. Therefore, it can prevent the accumulator in the MAC block from being overflowed without additional clock cycle in performing the MAC operation.

The present application contains subject matter related to Korean Patent Application No. 2006-0091313, filed in the Korean Intellectual Property Office on Sep. 20, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A digital signal processing apparatus performing a multiply-and-accumulate (MAC) operation, comprising:
a first memory for storing a plurality of first operands;
a second memory for storing a plurality of second operands;
a MAC processor including a plurality of parallel MAC blocks disposed in parallel for performing a parallel MAC operation on a first operand outputted from the first memory in parallel and a second operand outputted from the second memory in parallel using the parallel MAC blocks,
wherein the first memory and the second memory include dual port memories for outputting the plurality of the first operands and the second operands to the plurality of parallel MAC blocks in parallel.

2. The digital signal processing apparatus as recited in claim 1, wherein the first memory and the second memory include two dual port memories, and the MAC processor includes four parallel MAC blocks that perform a parallel MAC operation on four first operands outputted from the two dual port memories of the first memory and four second operands outputted from two dual port memories of the second memory in parallel.

3. The digital signal processing apparatus as recited in claim 2, wherein the first memory and the second memory includes:
a first dual port memory for storing an operand having an operand address having a least significant bit of ‘0’; and
a second dual port memory for storing an operand having an operand address having a most significant bit of ‘1’.

4. The digital signal processing apparatus as recited in claim 2, wherein the MAC block included in the MAC processor includes:
an accumulator for storing a MAC operation result;
an exponent counter for storing an exponent value that denotes the number of right-shifted bits of a values stored in the accumulator;
a multiplier for multiplying a first operand outputted from the first memory and a second operand outputted from the second memory;
a first right shifter for shifting an output value of the multiplier in a right direction as much as the exponent value;
an adder for adding an output value of the first right shifter and a value stored in the accumulator, and outputting a carry if the adding result exceeds a bit width supported by the accumulator; and
a second right shifter for shifting the adding result in a right direction by one when the carry is generated,
wherein the exponent counter increases the exponent value when the carry is generated, and the accumulator stores the output value of the second right shifter as the result of the MAC operation.

5. The digital signal processing apparatus as recited in claim 4, wherein the MAC processor further includes an arithmetic processor for adding four MAC operation results stored in the accumulators of the four MAC blocks.

6. The digital signal processing apparatus as recited in claim 4, wherein the arithmetic processor includes:
a shift means for shifting the four MAC operation results of the four MAC blocks as much as a difference between the largest exponent value among four exponent values stored in the exponent counters in the four MAC blocks and an exponent value stored in an exponent counter of a corresponding MAC block; and
an adding means for adding the shifted four MAC operation results.

7. An apparatus for performing a multiply-and-accumulate (MAC) operation on a first operand and a second operand, comprising:
an accumulator for storing a MAC operation result of the first operand and the second operand;
an exponent counter for storing an exponent value denoting the number of right-shifted bits of the MAC operation result stored in the accumulator;
a multiplier for multiplying the first operand and the second operand;
a first right shifter for shifting the multiplication result of the multiplier as much as the exponent value;
an adder for adding an output value of the first right shifter and a value stored in the accumulator, and outputting a carry when the adding result exceeds a bit width supported by the accumulator; and
a second right shifter for shifting the adding result in a right direction when the carry is generated,
wherein the exponent counter increases the stored exponent value when the carry is generated, and the accumulator stores the output value of the second right shifter as a new MAC operation result.

8. The apparatus as recited in claim 7, wherein the adder has a bit width identical to that of the accumulator.

9. The apparatus as recite in claim 7, wherein an exponent value in the exponent counter increases, and the new MAC operation result is stored in the accumulator at the same clock.

10. A storage device for storing an operand used in a parallel multiply-and-accumulate (MAC) operation of a digital signal processing apparatus having a plurality of MAC blocks arranged in parallel, comprising:
a storing unit for storing a plurality of operands used for a parallel MAC operation; and
an address generator for generating a plurality of operand addresses for outputting a plurality of operands from the storing unit in parallel,
wherein the storing unit is embodied as a dual port memory that allows simultaneous access of two memory regions.

11. The storage device as recited in claim 10, wherein the storing unit includes:
a first dual port memory for storing an operand having an odd address; and
a second dual port memory for storing an operand having an even address.

12. The storage device as recited in claim 11, wherein the address generator generates two addresses, one having a most significant bit of 1 for the first dual port memory, and the other having a lest significant bit of 0 for the second dual port memory.

13. The storage device as recited in claim 11, further comprising a MUX for selecting one of operands outputted from the first dual port memory and the second dual port memory.

14. A method of performing a multiply-and-accumulate (Mac) operation in a digital signal processing apparatus that performs a MAC operation of a first operand and a second operand, comprising the steps of:
a) storing an exponent value denoting a number of right shifted bits of a MAC operation result value stored in an accumulator;
b) multiplying the first operand and the second operand and shifting the multiplication result in a right direction as much as the exponent value;
c) adding the shifted multiplication result to a MAC operation result value stored in the accumulator;
d) shifting the adding result if the adding result exceeds a bit width of the accumulator;
e) storing the right-shifted adding value at the accumulator as a new MAC operation value; and
f) increasing an exponent value that increases the stored exponent value.

15. The method as recited in claim 14, wherein the step e) and the step f) are performed at the same clock.
